(19) United States
(12) Patent Application Publication
(10) Pub. No.: US 2025/0174896 A1
(43) Pub. Date: May 29, 2025

(54) COMMUNICATION DEVICE

(71) Applicant: Wistron NeWeb Corp., Hsinchu (TW)

(72) Inventors: Chung-Che LIEN, Hsinchu (TW); Chia-Hao CHANG, Hsinchu (TW); Ting-Han SHIH, Hsinchu (TW); Tzu-Kuan SUN, Hsinchu (TW)

(21) Appl. No.: 18/922,957

(22) Filed: Oct. 22, 2024

(30) Foreign Application Priority Data
Nov. 24, 2023 (TW) 112145567

(51) Int. Cl. H01Q 5/35; H01Q 1/48

(52) U.S. Cl. CPC H01Q 5/35; H01Q 1/48

(57) ABSTRACT

A communication device includes a metal ground element, a first antenna element, a second antenna element, a third antenna element, a fourth antenna element, a nonconductive support element, a first metal element, and a second metal element. The metal ground element has a slot region. The first antenna element, the second antenna element, the third antenna element, and the fourth antenna element are adjacent to the slot region. The first metal element is coupled to a ground voltage. The first metal element at least partially extends across the slot region. The second metal element is coupled to the ground voltage. The second metal element at least partially extends across the slot region. The first antenna element, the second antenna element, the third antenna element, the fourth antenna element, the first metal element, and the second metal element are disposed on the nonconductive support element.

### CROSS REFERENCE TO RELATED APPLICATIONS

This application claims priority of Taiwan Patent Application No. 112145567 filed on Nov. 24, 2023, the entirety of which is incorporated by reference herein.

### BACKGROUND OF THE DISCLOSURE

### Field of the Disclosure

The disclosure generally relates to a communication device, and more particularly, to a communication device with high isolation.

### Description of the Related Art

With the advancements being made in mobile communication technology, mobile devices such as portable computers, mobile phones, multimedia players, and other hybrid functional portable electronic devices have become more common. To satisfy consumer demand, mobile devices can usually perform wireless communication functions. Some devices cover a large wireless communication area; these include mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some devices cover a small wireless communication area; these include mobile phones using Wi-Fi systems and using frequency bands of 2.4 GHz, 5.2 GHz, and 5.8 GHz.

Antennas are indispensable elements of a mobile device supporting wireless communication. However, because of the small amount of internal space in the mobile device, the configuration of the antennas and their transmission lines are often very close, and they are likely to interfere with each other. Accordingly, it is necessary to propose a novel solution for solving the problem of low isolation in the conventional design.

### BRIEF SUMMARY OF THE DISCLOSURE

In an exemplary embodiment, the disclosure is directed to a communication device that includes a metal ground element, a first antenna element, a second antenna element, a third antenna element, a fourth antenna element, a nonconductive support element, a first metal element, and a second metal element. The metal ground element provides a ground voltage. The metal ground element has a slot region. The first antenna element has a first feeding point. The second antenna element has a second feeding point. The third antenna element has a third feeding point. The fourth antenna element has a fourth feeding point. The first antenna element, the second antenna element, the third antenna element, and the fourth antenna element are all adjacent to the slot region. The first metal element is coupled to the ground voltage. The first metal element at least partially extends across the slot region. The second metal element is coupled to the ground voltage. The second metal element at least partially extends across the slot region. The first antenna element, the second antenna element, the third antenna element, the fourth antenna element, the first metal element, and the second metal element are disposed on the nonconductive support element.

In another exemplary embodiment, the disclosure is directed to a communication device that includes a metal ground element, a first antenna element, a second antenna element, a metal element, and a nonconductive support element. The metal ground element provides a ground voltage. The metal ground element has a slot region. The first antenna element has a first feeding point. The second antenna element has a second feeding point. The first antenna element and the second antenna element are both adjacent to the slot region. The metal element is coupled to the ground voltage. The metal element at least partially extends across the slot region. The first antenna element, the second antenna element, and the metal element are disposed on the nonconductive support element.

### BRIEF DESCRIPTION OF DRAWINGS

The disclosure can be more fully understood by reading the subsequent detailed description and examples with references made to the accompanying drawings, wherein:

FIG. 1A is a perspective view of a communication device according to an embodiment of the disclosure;

FIG. 1B is a perspective view of a communication device according to another embodiment of the disclosure;

FIG. 2 is a front view of a communication device according to an embodiment of the disclosure;

FIG. 3 is a diagram of isolation of a first antenna element and a fourth antenna element according to an embodiment of the disclosure;

FIG. 4 is a diagram of isolation of a second antenna element and a third antenna element according to an embodiment of the disclosure; and

FIG. 5 is a perspective view of a communication device according to another embodiment of the disclosure.

### DETAILED DESCRIPTION OF THE DISCLOSURE

In order to illustrate the purposes, features and advantages of the disclosure, the embodiments and figures of the disclosure are shown in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

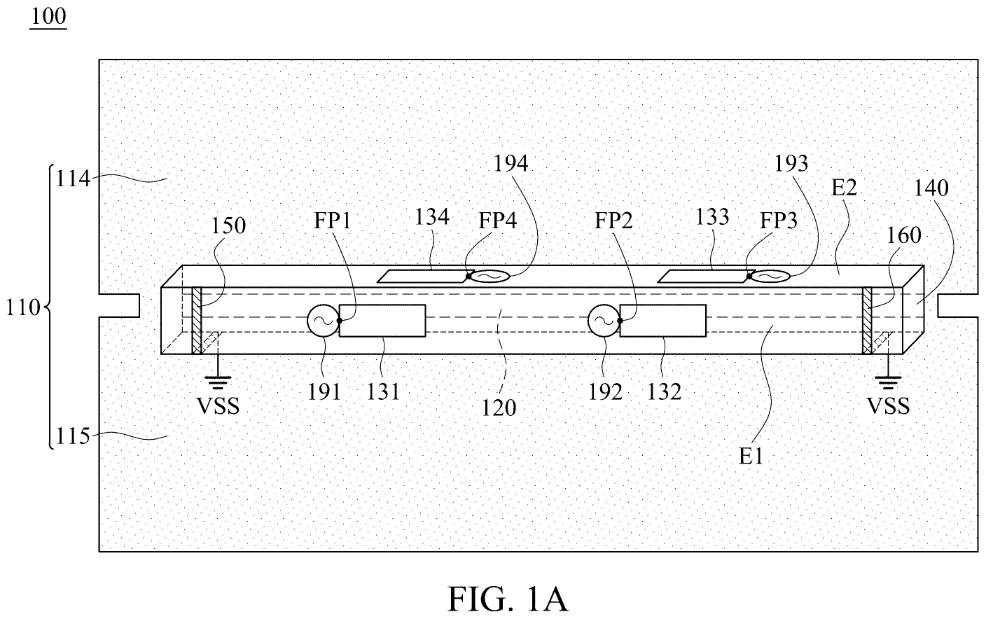

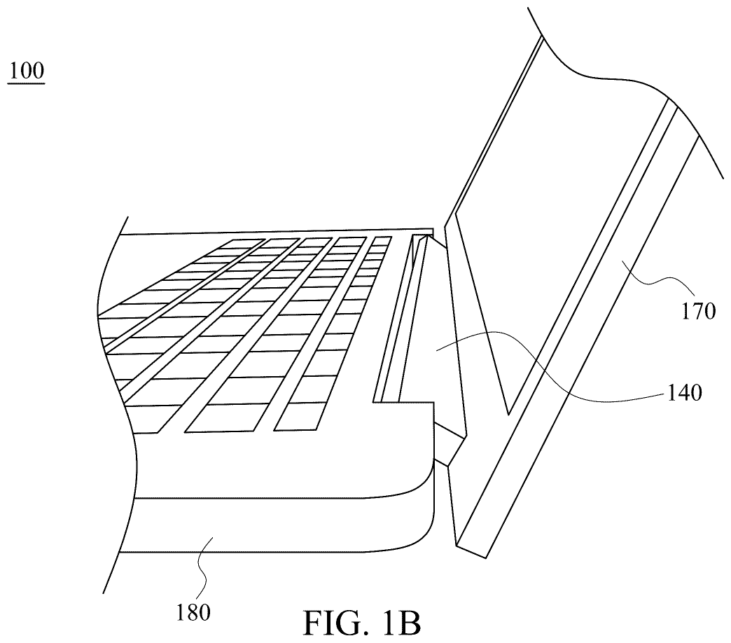

FIG. 1A is a perspective view of a communication device 100 according to an embodiment of the disclosure. The communication device 100 may be applied to a mobile device, such as a smart phone, a tablet computer, or a notebook computer. In the embodiment of FIG. 1A, the communication device 100 includes a metal ground element 110, a first antenna element 131, a second antenna element 132, a third antenna element 133, a fourth antenna element 134, a nonconductive support element 140, a first metal element 150, and a second metal element 160. It should be understood that the communication device 100 may further include other components, such as a processor, a touch control panel, a speaker, a power supply module, and/or a housing, although they are not displayed in FIG. 1A.

The metal ground element 110 provides a ground voltage VSS. The metal ground element 110 has a slot region 120. In some embodiments, the metal ground element 110 includes a combination of multiple ground elements. For example, the slot region 120 may substantially have a straight-line shape, but it is not limited thereto. In alternative embodiments, the slot region 120 substantially has an L-shape or a T-shape. Specifically, the metal ground element 110 includes a first portion 114 and a second portion 115 which are coupled to each other, and the slot region 120 is positioned between the first portion 114 and the second portion 115 of the metal ground element 110.

In some embodiments, if the communication device 100 is a notebook computer, the first portion 114 of the metal ground element 110 may be configured as an upper cover housing, and the second portion 115 of the metal ground element 110 may be configured as a base housing. It should be understood that the upper cover housing and the base housing as mentioned above are equivalent to the so-called “A-component” and “D-component” in the field of notebook computers, respectively. In other words, the slot region 120 may be adjacent to a hinge element (not shown) of the notebook computer.

The shapes and types of the first antenna element 131, the second antenna element 132, the third antenna element 133, and the fourth antenna element 134 are not limited in the disclosure. For example, any of the first antenna element 131, the second antenna element 132, the third antenna element 133, and the fourth antenna element 134 may be a coupled-fed antenna, a monopole antenna, a dipole antenna, a patch antenna, a loop antenna, a PIFA (Planar Inverted F Antenna), or a chip antenna.

The first antenna element 131, the second antenna element 132, the third antenna element 133, and the fourth antenna element 134 are all disposed adjacent to the slot region 120 of the metal ground element 110. The term “adjacent” or “close” over the disclosure means that the distance (spacing) between two corresponding elements is smaller than a predetermined distance (e.g., 10 mm or shorter), or means that the two corresponding elements directly touch each other (i.e., the aforementioned distance/spacing between them is reduced to 0).

The first antenna element 131 has a first feeding point FP1. The first feeding point FP1 is coupled to a first signal source 191. The second antenna element 132 has a second feeding point FP2. The second feeding point FP2 is coupled to a second signal source 192. The third antenna element 133 has a third feeding point FP3. The third feeding point FP3 is coupled to a third signal source 193. The fourth antenna element 134 has a fourth feeding point FP4. The fourth feeding point FP4 is coupled to a fourth signal source 194. The first signal source 191, the second signal source 192, the third signal source 193, and the fourth signal source 194 may be four RF (Radio Frequency) modules for exciting the first antenna element 131, the second antenna element 132, the third antenna element 133, and the fourth antenna element 134, respectively.

The nonconductive support element 140 can at least partially cover the slot region 120 of the metal ground element 110. The first antenna element 131, the second antenna element 132, the third antenna element 133, the fourth antenna element 134, the first metal element 150, and the second metal element 160 are all disposed on the nonconductive support element 140. In some embodiments, the nonconductive support element 140 has a first surface E1 and a second surface E2 which are different from each other. Both of the first feeding point FP1 and the second feeding point FP2 may be positioned on the first surface E1 of the nonconductive support element 140. Both of the third feeding point FP3 and the fourth feeding point FP4 may be positioned on the second surface E2 of the nonconductive support element 140. For example, the first surface E1 and the second surface E2 of the nonconductive support element 140 may be substantially perpendicular to each other.

FIG. 1B is a perspective view of the communication device 100 according to another embodiment of the disclosure. In the embodiment of FIG. 1B, the communication device 100 is a notebook computer. The nonconductive support element 140 is disposed between an upper cover housing 170 and a base housing 180 of the notebook computer, so as to support one or more antenna elements (not shown). For example, the nonconductive support element 140 may be considered as an extension portion of the upper cover housing 170, but it is not limited thereto.

The first metal element 150 is coupled to the ground voltage VSS. An open end of the first metal element 150 may extend in a direction across the slot region 120 of the metal ground element 110. The first metal element 150 can extend across at least one part of the slot region 120 of the metal ground element 110. The second metal element 160 is also coupled to the ground voltage VSS. An open end of the second metal element 160 may extend in a direction across the slot region 120 of the metal ground element 110. The second metal element 160 can extend across at least one part of the slot region 120 of the metal ground element 110. In other words, the first metal element 150 and the second metal element 160 have vertical projections on the metal ground element 110, and the vertical projections at least partially overlap the slot region 120. In some embodiments, the first metal element 150 and/or the second metal element 160 can be configured to be across the two opposite sides of the slot region 120. However, the disclosure is not limited thereto. In alternative embodiments, the first metal element 150 and/or the second metal element 160 can be configured to be merely across at least one part of the slot region 120. It should be noted that the first antenna element 131, the second antenna element 132, the third antenna element 133, and the fourth antenna element 134 are all disposed between the first metal element 150 and the second metal element 160. In alternative embodiments, the first metal element 150 and the second metal element 160 further extend onto the second surface E2 of the nonconductive support element 140, such that the two open ends of the first metal element 150 and the second metal element 160 can be aligned with the third feeding point FP3 and the fourth feeding point FP4.

According to practical measurements, since the first metal element 150 and the second metal element 160 provide additional capacitances, the isolation between the first antenna element 131, the second antenna element 132, the third antenna element 133, and the fourth antenna element 134 can be significantly enhanced in the proposed communication device 100 of the disclosure. The following embodiments will introduce different configurations and detailed structural features of the communication device 100. It should be understood that these figures and descriptions are merely exemplary, rather than limitations of the disclosure.

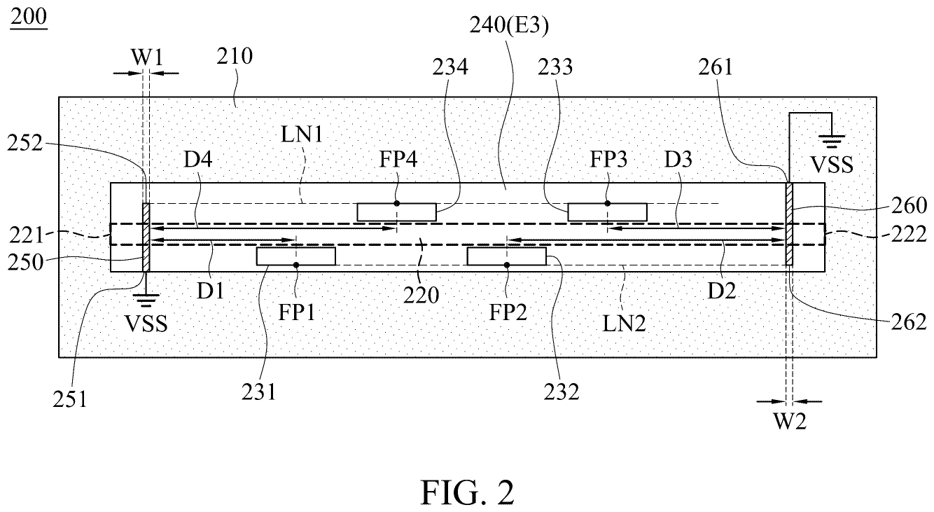

FIG. 2 is a front view of a communication device 200 according to an embodiment of the disclosure. FIG. 2 is similar to FIG. 1A. In the embodiment of FIG. 2, the communication device 200 includes a metal ground element 210, a first antenna element 231, a second antenna element 232, a third antenna element 233, a fourth antenna element 234, a nonconductive support element 240, a first metal element 250, and a second metal element 260.

The metal ground element 210 provides a ground voltage VSS. The metal ground element 210 has a slot region 220. The slot region 220 may be a closed slot with a first closed end 221 and a second closed end 222 away from each other. In some embodiments, the first metal element 250 is adjacent to the first closed end 221 of the slot region 220, and the second metal element 260 is adjacent to the second closed end 222 of the slot region 220.

The first antenna element 231, the second antenna element 232, the third antenna element 233, and the fourth antenna element 234 are all disposed adjacent to the slot region 220 of the metal ground element 210. In some embodiments, the first antenna element 231 and the second antenna element 232 are disposed at the same side (e.g., the lower side) of the slot region 220, and the third antenna element 233 and the fourth antenna element 234 are disposed at the opposite side (e.g., the upper side) of the slot region 220.

The nonconductive support element 240 can cover the whole slot region 220 of the metal ground element 210. The nonconductive support element 240 may be implemented with a dielectric substrate, such as an FR4 (Flame Retardant 4) substrate, a PCB (Printed Circuit Board), or an FPC (Flexible Printed Circuit). In some embodiments, a first feeding point FP1 of the first antenna element 231, a second feeding point FP2 of the second antenna element 232, a third feeding point FP3 of the third antenna element 233, and a fourth feeding point FP4 of the fourth antenna element 234 are all positioned on the same surface E3 of the nonconductive support element 240. Furthermore, the opposite surface of the nonconductive support element 240 may be attached to the metal ground element 210.

The first metal element 250 has a first end 251 and a second end 252. The first end 251 of the first metal element 250 is coupled to the ground voltage VSS. The second end 252 of the first metal element 250 is an open end extending across the slot region 220. In some embodiments, the first metal element 250 substantially has a straight-line shape, but it is not limited thereto. It should be noted that the second end 252 of the first metal element 250 can be aligned with both the third feeding point FP3 and the fourth feeding point FP4. In other words, the second end 252 of the first metal element 250, the third feeding point FP3, and the fourth feeding point FP4 can all be arranged in a first straight line LN1, so as to correspond to a high current-density region on the metal ground element 210.

The second metal element 260 has a first end 261 and a second end 262. The first end 261 of the second metal element 260 is coupled to the ground voltage VSS. The second end 262 of the second metal element 260 is an open end extending across the slot region 220. For example, the second end 262 of the second metal element 260 and the second end 252 of the first metal element 250 may substantially extend in opposite directions. In some embodiments, the second metal element 260 substantially has another straight-line shape, which may be substantially parallel to the first metal element 250, but it is not limited thereto. It should be noted that the second end 262 of the second metal element 260 can be aligned with both the first feeding point FP1 and the second feeding point FP2. In other words, the second end 262 of the second metal element 260, the first feeding point FP1, and the second feeding point FP2 can all be arranged in a second straight line LN2, so as to correspond to another high current-density region on the metal ground element 210. Furthermore, the second straight line LN2 may be substantially parallel to the aforementioned first straight line LN1.

In some embodiments, all of the first antenna element 231, the second antenna element 232, the third antenna element 233, and the fourth antenna element 234 can cover a first frequency band, a second frequency band, and a third frequency band. For example, the first frequency band may be from 2400 MHz to 2500 MHz, the second frequency band may be from 5150 MHz to 5850 MHz, and the third frequency band may be from 5925 MHz to 7125 MHz. Therefore, the communication device 200 can support at least the wideband operations of WLAN (Wireless Local Area Network) and Wi-Fi 6E.

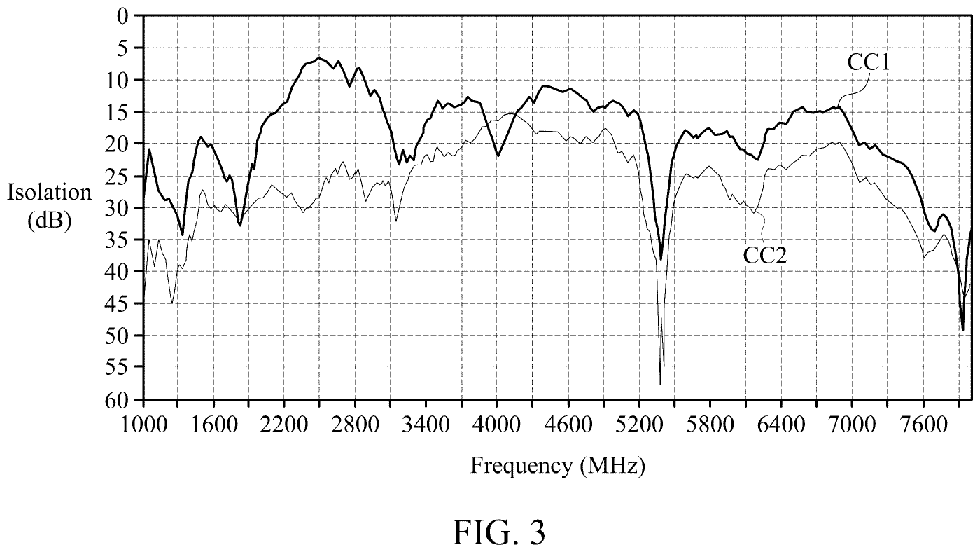

FIG. 3 is a diagram of isolation of the first antenna element 231 and the fourth antenna element 234 according to an embodiment of the disclosure. The horizontal axis represents the operational frequency (MHz), and the vertical axis represents the isolation (dB). For example, if the first feeding point FP1 is set as a first port (Port 1) and the fourth feeding point FP4 is set as a fourth port (Port 4), the absolute value of the S41 parameter between the first port and the fourth port can be considered as the isolation between the first antenna element 231 and the fourth antenna element 234. As shown in FIG. 3, a first curve CC1 represents the isolation characteristic of the communication device 200 without using the first metal element 250, and a second curve CC2 represents the isolation characteristic of the communication device 200 using the first metal element 250. It should be understood that the first antenna element 231 and the fourth antenna element 234 can be excited together to generate in-phase currents relative to the slot region 220. The constructive interference can be induced between the corresponding electric field of the in-phase currents and the effective capacitance of the first metal element 250, thereby improving the antenna isolation of the communication device 200. According to the measurement of FIG. 3, after the first metal element 250 is used, the isolation between the first metal element 231 and the fourth antenna element 234 can reach at least 30 dB, and it can meet the requirements of application of general mobile communication devices.

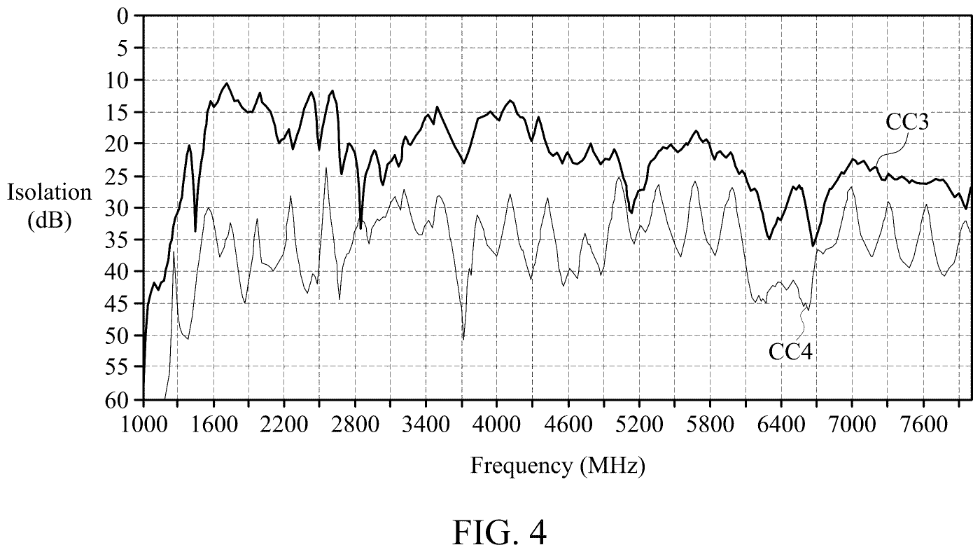

FIG. 4 is a diagram of isolation of the second antenna element 232 and the third antenna element 233 according to an embodiment of the disclosure. The horizontal axis represents the operational frequency (MHz), and the vertical axis represents the isolation (dB). For example, if the second feeding point FP2 is set as a second port (Port 2) and the third feeding point FP3 is set as a third port (Port 3), the absolute value of the S32 parameter between the second port and the third port can be considered as the isolation between the second antenna element 232 and the third antenna element 233. As shown in FIG. 4, a third curve CC3 represents the isolation characteristic of the communication device 200 without using the second metal element 260, and a fourth curve CC4 represents the isolation characteristic of the communication device 200 using the second metal element 260. It should be understood that the second antenna element 232 and the third antenna element 233 can be excited together to generate in-phase currents relative to the slot region 220. The constructive interference can be induced between the corresponding electric field of the in-phase currents and the effective capacitance of the second metal element 260, thereby improving the antenna isolation of the communication device 200. According to the measurement of FIG. 4, after the second metal element 260 is used, the isolation between the second metal element 232 and the third antenna element 233 can reach at least 30 dB, and it can meet the requirements of application of general mobile communication devices.

In some embodiments, the element sizes of the communication device 200 will be described as follows. The first distance D1 between the first feeding point FP1 and the first metal element 250 may be substantially equal to 0.25 wavelength (λ/4) of the first frequency band of the communication device 200. The second distance D2 between the second feeding point FP2 and the second metal element 260 may be substantially equal to 0.5 wavelength (22) of the first frequency band of the communication device 200. The third distance D3 between the third feeding point FP3 and the second metal element 260 may be substantially equal to 0.25 wavelength (24) of the first frequency band of the communication device 200. The fourth distance D4 between the fourth feeding point FP4 and the first metal element 250 may be substantially equal to 0.5 wavelength (λ/2) of the first frequency band of the communication device 200. The width W1 of the first metal element 250 may be greater than or equal to 0.2 mm. The width W2 of the second metal element 260 may be greater than or equal to 0.2 mm. The above ranges of element sizes are calculated and obtained according to many experiment results, and they help to optimize the isolation, the operational bandwidth, and the impedance matching of the communication device 200.

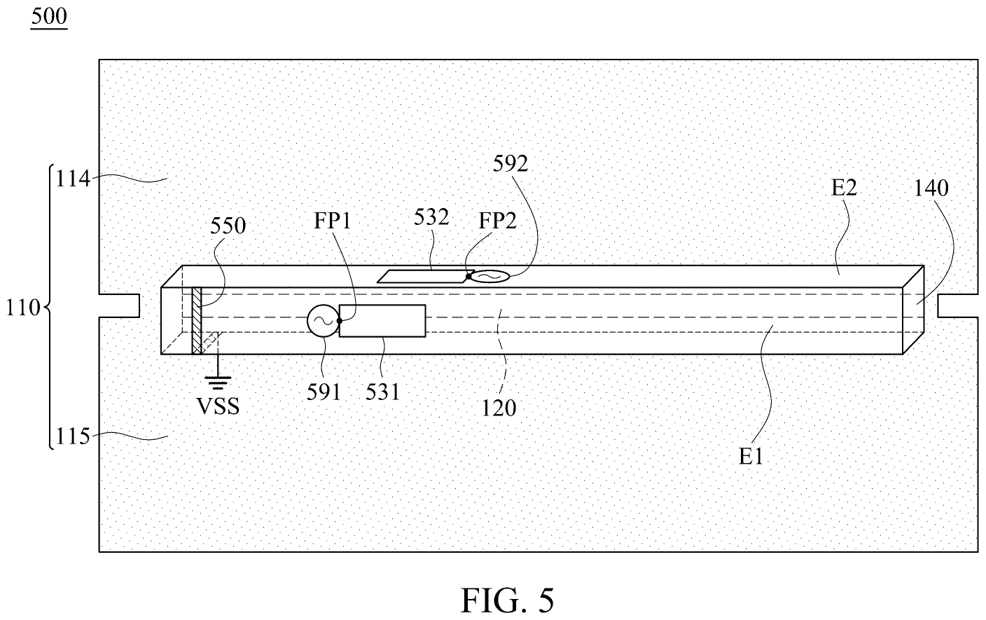

FIG. 5 is a perspective view of a communication device 500 according to another embodiment of the disclosure. FIG. 5 is similar to FIG. 1A. In the embodiment of FIG. 5, the communication device 500 at least includes the aforementioned metal ground element 110, a first antenna element 531, a second antenna element 532, the aforementioned nonconductive support element 140, and a metal element 550. In other words, the communication device 500 does not include the third antenna element and the fourth antenna element as mentioned above. The first antenna element 531 has a first feeding point FP1. The first feeding point FP1 is coupled to a first signal source 591. The second antenna element 532 has a second feeding point FP2. The second feeding point FP2 is coupled to a second signal source 592. The first antenna element 531, the second antenna element 532, and the metal element 550 are all disposed on the nonconductive support element 140. Both of the first antenna element 531 and the second antenna element 532 are adjacent to the slot region 120 of the metal ground element 110. For example, the first antenna element 531 and the first feeding point FP1 may be positioned on the first surface E1 of the nonconductive support element 140, and the second antenna element 532 and the second feeding point FP2 may be positioned on the second surface E2 of the nonconductive support element 140. The metal element 550 is coupled to the ground voltage VSS. The metal element 550 can at least partially extend across the slot region 120 of the metal ground element 110. Furthermore, both of the first antenna element 531 and the second antenna element 532 are adjacent to the metal element 550. According to practical measurements, the metal element 550 can also increase the isolation between the first antenna element 531 and the second antenna element 532. Other features of the communication device 500 of FIG. 5 are similar to those of the communication device 100 of FIG. 1A. Therefore, the two embodiments can achieve similar levels of performance.

The disclosure proposes a novel communication device. In comparison to the conventional design, the disclosure has at least the advantages of high isolation, small size, wide bandwidth, and low manufacturing cost. Therefore, the disclosure is suitable for application in a variety of mobile devices or IoT (Internet of Things).

Note that the above element sizes, element shapes, and frequency ranges are not limitations of the disclosure. A designer can fine-tune these settings or values according to different requirements. It should be understood that the communication device of the disclosure is not limited to the configurations of FIGS. 1-5. The disclosure may merely include any one or more features of any one or more embodiments of FIGS. 1-5. In other words, not all of the features displayed in the figures should be implemented in the communication device of the disclosure.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A communication device, comprising:
a metal ground element, providing a ground voltage, wherein the metal ground element has a slot region;
a first antenna element, having a first feeding point;
a second antenna element, having a second feeding point;
a third antenna element, having a third feeding point;
a fourth antenna element, having a fourth feeding point, wherein the first antenna element, the second antenna element, the third antenna element, and the fourth antenna element are adjacent to the slot region;
a first metal element, coupled to the ground voltage, wherein the first metal element at least partially extends across the slot region;
a second metal element, coupled to the ground voltage, wherein the second metal element at least partially extends across the slot region; and
a nonconductive support element, wherein the first antenna element, the second antenna element, the third antenna element, the fourth antenna element, the first metal element, and the second metal element are disposed on the nonconductive support element.

2. The communication device as claimed in claim 1, wherein the metal ground element comprises a first portion and a second portion coupled to each other, and the slot region is positioned between the first portion and the second portion.

3. The communication device as claimed in claim 2, wherein the first portion of the metal ground element is configured as an upper cover housing, and the second portion of the metal ground element is configured as a base housing.

4. The communication device as claimed in claim 1, wherein the slot region substantially has a straight-line shape.

5. The communication device as claimed in claim 1, wherein the slot region is a closed slot with a first closed end and a second closed end.

6. The communication device as claimed in claim 5, wherein the first metal element is adjacent to the first closed end of the slot region, and the second metal element is adjacent to the second closed end of the slot region.

7. The communication device as claimed in claim 1, wherein the first antenna element, the second antenna element, the third antenna element, and the fourth antenna element are disposed between the first metal element and the second metal element.

8. The communication device as claimed in claim 1, wherein the nonconductive support element has a first surface and a second surface different from each other, the first feeding point and the second feeding point are positioned on the first surface, and the third feeding point and the fourth feeding point are positioned on the second surface.

9. The communication device as claimed in claim 1, wherein the first feeding point, the second feeding point, the third feeding point, and the fourth feeding point are positioned on a same surface of the nonconductive support element.

10. The communication device as claimed in claim 1, wherein all of the first antenna element, the second antenna element, the third antenna element, and the fourth antenna element cover a first frequency band, a second frequency band, and a third frequency band.

11. The communication device as claimed in claim 10, wherein the first frequency band is from 2400 MHz to 2500 MHz, the second frequency band is from 5150 MHz to 5850 MHz, and the third frequency band is from 5925 MHz to 7125 MHz.

12. The communication device as claimed in claim 10, wherein a first distance between the first feeding point and the first metal element is substantially equal to 0.25 wavelength of the first frequency band.

13. The communication device as claimed in claim 10, wherein a second distance between the second feeding point and the second metal element is substantially equal to 0.5 wavelength of the first frequency band.

14. The communication device as claimed in claim 10, wherein a third distance between the third feeding point and the second metal element is substantially equal to 0.25 wavelength of the first frequency band.

15. The communication device as claimed in claim 10, wherein a fourth distance between the fourth feeding point and the first metal element is substantially equal to 0.5 wavelength of the first frequency band.

16. The communication device as claimed in claim 1, wherein a width of each of the first metal element and the second metal element is greater than or equal to 0.2 mm.

17. The communication device as claimed in claim 1, wherein an open end of the first metal element is aligned with the third feeding point and the fourth feeding point.

18. The communication device as claimed in claim 1, wherein an open end of the second metal element is aligned with the first feeding point and the second feeding point.

19. A communication device, comprising:
a metal ground element, providing a ground voltage, wherein the metal ground element has a slot region;
a first antenna element, having a first feeding point;
a second antenna element, having a second feeding point, wherein the first antenna element and the second antenna element are adjacent to the slot region;
a metal element, coupled to the ground voltage, wherein the metal element at least partially extends across the slot region; and
a nonconductive support element, wherein the first antenna element, the second antenna element, and the metal element are disposed on the nonconductive support element.

20. The communication device as claimed in claim 19, wherein the first antenna element and the second antenna element are adjacent to the metal element.
